(19) United States
(12) Patent Application Publication
(10) Pub. No.: US 2018/0135564 A1
(43) Pub. Date: May 17, 2018

(54) PROPANE SHUTOFF SYSTEM

(71) Applicant: Amano Pioneer Eclipse Corporation, Sparta, NC (US)

(72) Inventors: Derrick Lee Hamm, Sparta, NC (US); Ted Tilman Wagoner, Ennice, NC (US); David Bost, Independence, VA (US)

(21) Appl. No.: 15/354,618

(22) Filed: Nov. 17, 2016

(51) Int. Cl. F02M 21/02; F02D 41/22

(52) U.S. Cl. CPC F02M 21/0242; F02D 2041/224; F02D 41/22; F02M 21/0212

(57) ABSTRACT

The present invention relates to a propane shutoff system. The system may include a regulator having a first section, and may further include a fuel lock-off in fluid communication with the regulator. The fuel lock-off is operable to stop a flow of fuel into the regulator. The system may also include a high pressure switch for monitoring pressure entering the regulator, and a low pressure switch for monitoring pressure within the first section of the regulator. The high pressure switch may cause the fuel lock-off to stop the flow of fuel into the regulator upon detection of a pressure entering the regulator higher than a predetermined value. The low pressure switch may cause the fuel lock-off to stop the flow of fuel into the regulator upon detection of a pressure within the regulator higher than a predetermined value.

### FIELD OF THE INVENTION

The present invention relates to a propane shutoff system, and, more particularly, to a system for detecting high or low pressure conditions for propane fed into an engine and shutting down the flow of propane when out-of-tolerance conditions are found.

### BACKGROUND OF THE INVENTION

Propane can be used as a fuel source for machines with internal combustion engines. Reasons for using propane over gasoline or diesel include reduced emissions, sealed fuel containers for reduced fire hazard, and reduced engine maintenance costs.

There are two styles of propane cylinders that are used for these machines: vapor service and liquid service. A properly filled propane cylinder, (either liquid service or vapor service), is filled with liquid propane to approximately 80% capacity. The remaining ˜20% is used to allow liquid propane to expand and/or vaporize. Thus, while all propane cylinders store liquid propane, the difference is how the propane is dispensed from the cylinder. A liquid service cylinder typically includes a tube that draws liquid propane from the bottom of the cylinder. The liquid propane is then provided to a device through a service valve. The service valve connects the propane cylinder to a device's fuel hose. Propane-powered forklifts often use liquid service propane cylinders, as an example. A vapor service cylinder, on the other hand, allows vapor propane—typically at the top of the cylinder—to exit the cylinder through a service valve. Gas grill cylinders are typically vapor service cylinders, as one example.

Vapor propane is also used as a fuel for engines for small commercial machines. Examples of these machines include floor burnishers, concrete grinders, and lawn mowers. Vapor propane is used for these types of machines for several reasons. For example, vapor propane is clean and free of oils and other contaminants that may be in the bottom of the propane cylinder. Such contaminants may be drawn from a liquid service cylinder, but a vapor service cylinder avoids this problem. Additionally, with vapor cylinders, a vaporizer is not required on the machine's fuel system to convert the propane from liquid propane to vapor propane. Vapor propane also provides more consistent engine startability at various temperatures.

Most end users have their propane cylinders filled in one of two ways. They take their cylinders to a propane filling station and have them refilled, or an exchange service picks up empty propane cylinders and replaces them with filled propane cylinders. However, the filling and delivery of propane cylinders is unregulated, and the personnel who fill or handle the cylinders may be inadequately trained. This can result in cylinders being overfilled, or the wrong type of cylinder being exchanged, or both.

Overfilled cylinders create safety, performance, and reliability issues. For example, overfilled containers may allow excess pressure (i.e., liquid propane) to escape through a pressure relief valve. This can result in safety hazards. Additionally, overfilled vapor cylinders and liquid service cylinders can result in liquid propane exiting through the service valve, and entering the propane regulator. This results in the engine operating with a “rich” air/fuel ratio, leading to significant Carbon Monoxide, (CO), increase due to the liquid propane having a density ˜270 times higher compared to vapor propane. This can also increase the risk of fire hazard, because all fuel may not be consumed in the combustion chamber. This unburned fuel passes to the catalyzed muffler. The reaction of the catalyst to the emissions is exothermic. The richer the mixture, the higher emissions, the hotter the catalyst. The catalyst can become hot enough to ignite unburned propane when it is expelled from the muffler. This results in the machine potentially producing a flame out of the muffler. And of course, when liquid propane is used in a system designed for vapor propane, damage to the system can occur.

### BRIEF SUMMARY OF THE INVENTION

The present invention relates to a propane shutoff system. The system may include a regulator having a first section, and may further include a fuel lock-off in fluid communication with the regulator. The fuel lock-off is operable to stop a flow of fuel into the regulator. The system may also include a high pressure switch for monitoring pressure entering the regulator, and a low pressure switch for monitoring pressure within the first section of the regulator. The high pressure switch may cause the fuel lock-off to stop the flow of fuel into the regulator upon detection of a pressure at the entrance of the regulator higher than a predetermined upper value or threshold. The low pressure switch may cause the fuel lock-off to stop the flow of fuel into the regulator upon detection of a pressure within the regulator higher than a predetermined lower value or threshold.

### BRIEF DESCRIPTION OF THE DRAWINGS

FIG. 1 is a perspective view of an example floor propane-fed device including a propane shutoff system according to an embodiment of the present invention.

FIG. 2 is a diagram of the propane shutoff system as partially removed from the propane-fed device of FIG. 1.

While the disclosure is susceptible to various modifications and alternative forms, a specific embodiment thereof is shown by way of example in the drawing and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION OF THE INVENTION

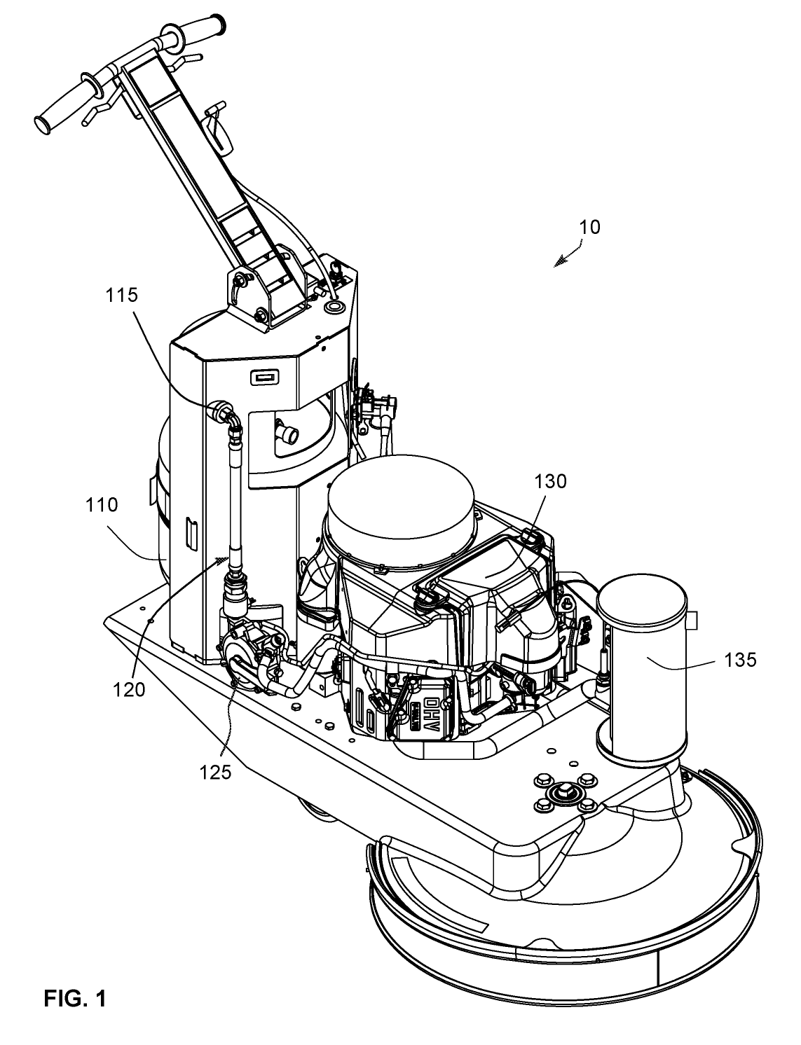

Referring to the drawings particularly by reference numbers wherein like numerals refer to like parts, FIG. 1 illustrates a perspective view of a an example propane-fed device 10. As shown, the propane-fed device 10 is a floor burnisher 10, although it will be understood that machines other than floor burnishers may also be used. As shown, floor burnisher 10 includes a vapor service propane cylinder 110. Vapor propane exits the cylinder 110 through the service valve 115, and passes through the propane shutoff system 120. From the shutoff system 120, propane passes into the regulator 125 and into then the engine 130. Within engine 130, the propane fuel is combusted to generate power for the floor burnisher 10, and the exhaust is passed to the catalyzed muffler 135 to be exhausted.

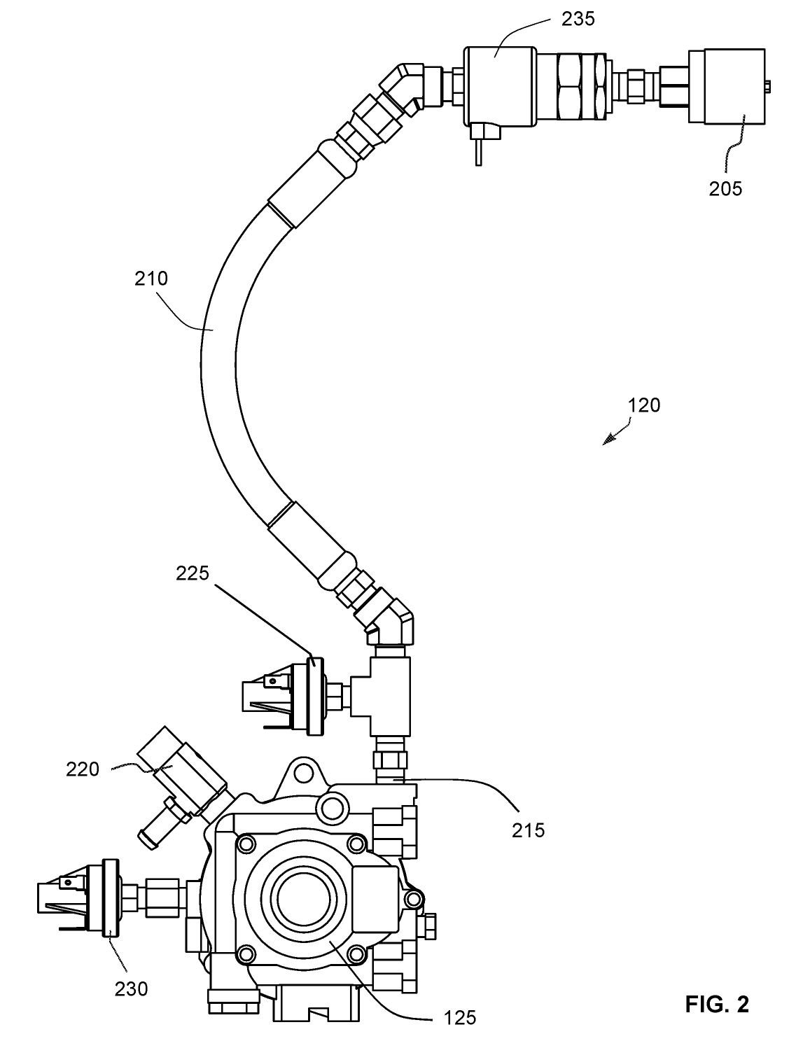

FIG. 2 illustrates a diagram of an example propane shutoff system 120 according to an example embodiment. The propane shutoff system 120 is shown in FIG. 2 as engaged with a regulator 125. Regulator 125 may be a standard regulator as would be understood in the field. The propane shutoff system 120 includes a fuel coupling 205 that connects to the service valve 115 of the cylinder 110. Propane flows through the fuel coupling 205 and into a hose 210, which may be a high pressure hose 210. Hose 210 is coupled to a regulator inlet 215 of regulator 125, allowing propane to flow into the regulator 125. After passing through the regulator 125, propane exits the regulator 125 through regulator outlet 220. However, a high pressure switch 225 is provided before the regulator inlet 215, and a low pressure switch 230 is provided at an initial stage area of regulator 125. The high and low pressure switches 225, 230 are in electrical communication with a fuel lock-off 235 that may be positioned below the fuel coupling 205.

In operation, the fuel lock-off 235 may be a normally-closed device, such that fuel lock-off 235 remains closed unless it receives electrical or other power. When inactive, the fuel lock-off prevents propane fuel from entering the hose 210 (and thereby the floor burnisher 10). It is only when the fuel lock-off is supplied power that it allows propane fuel to pass therethrough. This system is preferred for safety reasons, but a normally-open fuel lock-off 235 is also contemplated, as would be understood by a person of ordinary skill in the art.

Thus, when the floor burnisher 10 is powered on, power is provided to both the high and low pressure switches 225, 230. The high and low pressure switches 225, 230 provide such power to the fuel lock-off 235 so long as the pressure read by these two switches 225, 230 is within their respective tolerances. However, if the pressure detected by either or both the high and low pressure switches 225, 230 is out of tolerance, the out-of-tolerance switch(es) cut power to the fuel lock-off 235, thereby cutting off the flow of propane fuel to the floor burnisher 10.

As will be understood, the high and low pressure switches 225, 230 may be connected in parallel to one another, or in series with one another, prior to connection with the fuel lock-off 235. Preferably it only takes one switch 225, 230 to detect an out-of-tolerance condition to trigger the disablement of the fuel lock-off 235. Different wiring would therefore be used for the switches 225, 230 in series with one another versus in parallel with one another, as would be understood by a person of ordinary skill in the art.

The actual pressure levels within the shutoff system 120 may be measured by one or more pressure sensors (not shown). In an example embodiment, (and as shown in FIG. 2), the high and low pressure switches 225, 230 may incorporate such pressure sensors such that the sensors are not visible. Alternatively, one or more pressure sensors may be located where FIG. 2 shows the switches 225, 230, and the actual switches 225, 230 may be located remotely. Pressure switches 225, 230 would then be in communication with the pressure sensors. In yet another embodiment, the sensors may be in communication with a controller, such as a PLC or a processor or the like. Such electronics may then act as the high and low pressure switches 225, 230 by reading data from the pressure sensors and instructing the fuel lock-off 235 when to open or close.

In the event that an overfilled cylinder is used, the high pressure switch 225 will detect a high-pressure seeking to enter the regulator 125, and will stop electricity from flowing to the fuel lock-off 235. In an example embodiment, the high pressure switch 225 may activate at pressure above 200 psi. However, it will be understood that a reasonable activation range for the high pressure switch 225 would be between about 175 psi and 250 psi. This action stops propane from entering the high pressure hose 210 and renders the machine inoperable. Additionally, the high pressure switch 225 can be configured to supply voltage to an indicator light (not shown), or some other type of indicator, when a high pressure condition is detected, in order to inform the operator as to why the engine stopped operating.

In the event that a liquid service cylinder is accidentally used or lower pressure liquid propane exits the cylinder 110, the low pressure switch 230 will activate and stop electricity from flowing to the fuel lock-off 235. In an example embodiment, the low pressure switch 230 may activate at about 6 psi. However, it will be understood that a reasonable activation range for the low pressure switch 230 is approximately 5.5 to 8 psi. This action stops propane from entering the high pressure hose 210 and renders the machine inoperable. Additionally, the low pressure switch 230 can be configured to supply voltage to an indicator light (not shown) when a low pressure condition is detected, in order to inform the operator as to why the engine stopped operating.

In both instances, the pressure switches 225, 230 may be configured to control positive or negative voltage supplied to the fuel lock-off 235. In addition, the switches 225, 230 may be configured to control the ignition system of the engine as a means to stop operation. The switches 225, 230 may also or instead be configured to control the engine's vacuum system as a means to stop operation. Alternatively, the switches 225, 230 could be configured to only provide the operator with indication that a fault has occurred and not stop engine operation.

The concept presented above is explained as a shut-down and/or indicator feature for both overfilled cylinders and liquid service cylinders. A person of skill in the art would recognize that this system could be reconfigured for different purposes. For example, a forklift that is designed to operate on liquid service cylinders could be equipped with just the high pressure switch 225, and not the low pressure switch 230. Other machines would also benefit from such a device.

Thus, there has been shown and described several embodiments of a novel propane shutoff system. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A system comprising:
a regulator having a first section;
a fuel lock-off in fluid communication with the regulator, wherein said fuel lock-off is operable to stop a flow of fuel into the regulator;
a high pressure switch for monitoring pressure entering the regulator;
a low pressure switch for monitoring pressure within the first section of the regulator;
wherein said high pressure switch causes the fuel lock-off to stop the flow of fuel into the regulator upon detection of a pressure entering the regulator higher than a first predetermined value; and
wherein said low pressure switch causes the fuel lock-off to stop the flow of fuel into the regulator upon detection of a pressure within the regulator higher than a second predetermined value.

2. The system of claim 1 wherein a regulator inlet of the regulator is in fluid communication with the high pressure switch.

3. The system of claim 1 wherein the high pressure switch is in fluid communication with the fuel lock-off via a high pressure hose.

4. The system of claim 1 wherein the fuel lock-off is in fluid communication with a fuel coupling, and wherein said fuel coupling is sized and shaped to engage with a service valve of a propane cylinder.

5. The system of claim 1 wherein the fuel lock-off is a normally-closed valve that opens upon supply of power.

6. The system of claim 5 wherein the high pressure switch is in electrical communication with the fuel lock-off to provide electrical power to the fuel lock-off when a pressure condition entering the regulator below the first predetermined value is detected.

7. The system of claim 6 wherein the high pressure switch discontinues the provision of electrical power to the fuel lock-off upon detection of a pressure condition entering the regulator above the first predetermined value.

8. The system of claim 5 wherein the low pressure switch is in electrical communication with the fuel lock-off to provide electrical power to the fuel lock-off when a pressure condition within the regulator below the second predetermined value is detected.

9. The system of claim 8 wherein the low pressure switch discontinues the provision of electrical power to the fuel lock-off upon detection of a pressure condition within the regulator above the second predetermined value.

10. The system of claim 1 where the first predetermined value entering the regulator is between approximately 175 and 250-psi.

11. The system of claim 10 wherein the first predetermined value entering the regulator is approximately 200-psi

12. The system of claim 1 where the second predetermined value within the regulator is between approximately 5.5 and 8-psi.

13. The system of claim 12 wherein the second predetermined value within the regulator is approximately 6-psi

14. The system of claim 1 wherein at least one of said high pressure sensor and said low pressure sensor are in electrical communication with an indicator device.

15. The system of claim 14 wherein the low pressure switch provides electrical power to the indicator device when a pressure condition within the regulator below the second predetermined value is detected.

16. The system of claim 14 wherein the high pressure switch provides electrical power to the indicator device when a pressure condition entering the regulator above the first predetermined value is detected.

17. The system of claim 14 wherein the indicator device is at least one of an alarm and a light bulb.

18. The system of claim 1 wherein the high pressure switch includes a pressure sensor.

19. The system of claim 1 wherein the low pressure switch includes a pressure sensor.

20. A system comprising:
a regulator having a first section;
a fuel lock-off in fluid communication with the regulator, wherein said fuel lock-off is operable to stop a flow of fuel into the regulator;
a high pressure sensor for monitoring pressure entering the regulator;
a low pressure sensor for monitoring pressure within the first section of the regulator;
wherein said high pressure sensor and said low pressure sensor are in communication with a controller; and
wherein said controller causes the fuel lock-off to stop the flow of fuel into the regulator upon detection of a high pressure condition entering the regulator above a first predetermined value or upon detection of a low pressure condition within the regulator above a second predetermined value.
